(19) United States
(12) Patent Application Publication
(10) Pub. No.: US 2001/0051509 A1
(43) Pub. Date: Dec. 13, 2001

(54) Portable terminal

(75) Inventors: Hiromu Mukai, Osaka (JP); Hitoshi Hagimori, Ikoma-shi (JP); Minoru Kuwana, Osaka (JP); Tsutomu Honda, Osaka (JP); Kazuhiko Ishimaru, Osaka (JP); Hideki Nagata, Kobe-shi (JP)

Correspondence Address: McDERMOTT, WILL & EMERY, 600 13th Street, N.W., Washington, DC, 20005, US

(73) Assignee: Minolta Co., Ltd.

(21) Appl. No.: 09/874,256

(22) Filed: Jun. 6, 2001

(30) Foreign Application Priority Data
Jun. 8, 2000 (JP) P2000-171980

(51) Int. Cl. H04B 1/38

(52) U.S. Cl. 455/90; 455/550

(57) ABSTRACT

In a mobile telephone (1), an image pickup unit (20) that is allowed to freely pivot centered on axes that are directed in a lateral direction and a longitudinal direction. The image pickup unit (20) is allowed to pivot in accordance with the operation of a joystick placed on the rear face of a main body (10). Thus, it is possible to easily obtain a desired image without the need of changing the orientation of the main body (10). Moreover, the image pickup unit (20) is rotated by 90° centered on an axis extended from the front to rear direction so that it is possible to provide an image obtained by replacing the length in the longitudinal direction with the length in the lateral direction of the original image.

This application is based on application No. 2000-171980 filed in Japan, the contents of which are hereby incorporated by reference.

### BACKGROUND OF THE INVENTION

1. Field of the Invention

The present invention relates to a portable terminal which transmits and receives information.

2. Description of the Background Art

Various devices have been proposed in which a small-size image pickup unit (that is, a digital camera) is installed in a device such as a mobile telephone, a PHS (Personal Handy Phone System) and a portable personal computer. For example, Japanese Patent Application Laid-Open Nos. 6-292195(1994), 11-136554(1999) and 10-65780(1998) have proposed a mobile telephone in which an image pickup unit is secured to its main body. Moreover, there are some personal computers in which an image pickup unit that is allowed to pivot longitudinally is attached to an upper portion of the display thereof or a hinge portion between the display and a keyboard. In the mobile telephone provided with such an image pickup unit is capable of transmitting image data picked up by the image pickup unit as an attached file, etc., of an electronic mail.

However, in the conventional portable terminal, the image pickup unit is secured to the main body, or allowed to pivot centered on only one axis; consequently, it is not possible to direct the image pickup unit in a desired direction with respect to the main body. The resulting problem is that, for example, images which can be picked up are limited depending on the orientation of the main body when it is used. Moreover, in the case of a portable computer also, it is not possible to obtain a desired image unless the orientation of the main body is changed or shifted. Furthermore, in the conventional portable terminal, the image pickup unit itself needs to be rotated, with the result that it is difficult to pick up a desired image by the operation using one hand.

### SUMMARY OF THE INVENTION

A portable terminal for transmitting and receiving information in accordance with the present invention is provided with: a main body; an image pickup unit having an optical system and an image pickup element, for picking up an image of a subject; and a pivot mechanism for supporting the image pickup unit so as to allow it to freely pivot centered on at least two axes with respect to the main body.

In accordance with this invention, it is possible to easily pick up a desired image without the need of changing the orientation of the main body.

Preferably, the image pickup unit is virtually housed into the main body.

In accordance with one aspect of the present invention, the portable terminal is further provided with: a driving section for allowing the image pickup unit to pivot centered on at least two axes; and an input section for receiving inputs of at least two parameters as operation inputs of a pivotal operation of the image pickup unit. The image pickup section is allowed to pivot by utilizing the input section.

In accordance with another aspect of the present invention, the image pickup unit is directed to the front face side and the rear face side of the main body. Thus, it is possible to pick up an image on both of the front face side and the rear face side.

It is therefore an object of the present invention to provide a portable terminal which can easily obtain a desired image and is superior in the operability when the desired image is obtained.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view that shows the appearance of a front face side of a mobile telephone in accordance with a first preferred embodiment;

FIG. 2 is a perspective view that shows the appearance of a rear face side of the mobile telephone shown in FIG. 1;

FIG. 3 is a cross-sectional view that shows a structure of an image pickup unit;

FIG. 4 is a side view that shows a structure on the periphery of the image pickup unit;

FIG. 5 is a front view that shows a structure on the periphery of the image pickup unit;

FIG. 6 is a side view that shows a first driving section;

FIG. 7 is a bottom view of the first driving section shown in FIG. 6;

FIG. 8 is a block diagram that shows a functional structure of a mobile telephone;

FIG. 9 is a side view that shows an image pickup unit;

FIG. 10 is a side view that shows the image pickup unit;

FIG. 11 is a front view that shows the image pickup unit;

FIG. 12 is a front view that shows the image pickup unit;

FIG. 13 is a block diagram that shows a functional construction that relates to a format alteration;

FIG. 14 is a perspective view that shows the appearance of the front face side of the mobile telephone in accordance with a second preferred embodiment;

FIG. 15 is a perspective view that shows the appearance of the rear face side of the mobile telephone shown in FIG. 14;

FIG. 16 is a block diagram that shows a functional construction related to an image pickup process of a person's face;

FIG. 17 is a flow chart that shows a sequence of operations related to the image pickup process of a person's face;

FIG. 18 is a drawing that shows a jog dial and a structure related to the jog dial; and

FIGS. 19 to 25 are drawings that show modified examples of the mobile telephone.

### DESCRIPTION OF THE PREFERRED EMBODIMENTS

<1. First Preferred Embodiment>

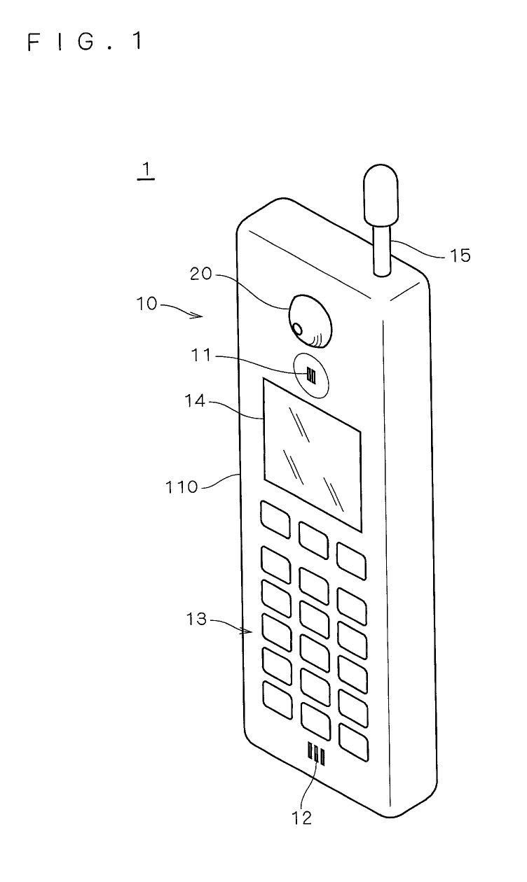

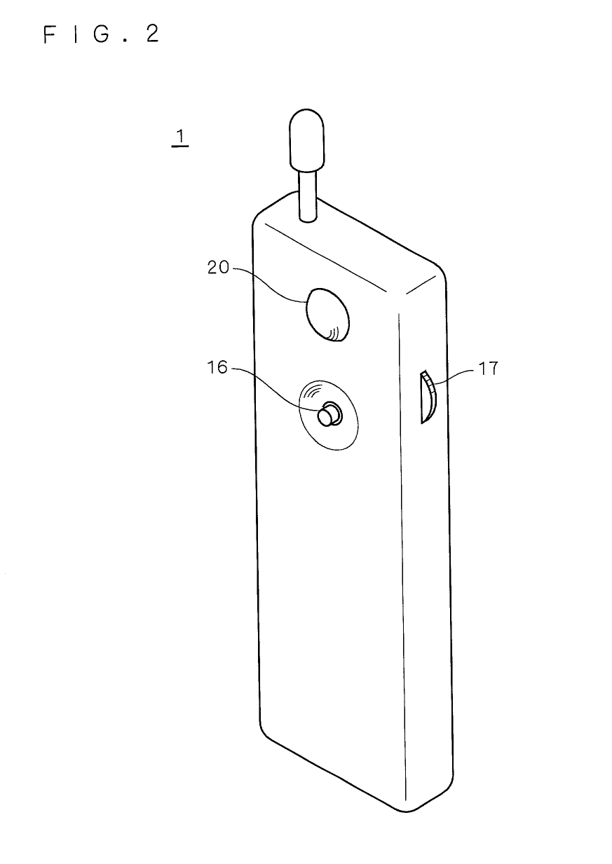

FIG. 1 is a perspective view that shows the appearance of the front face side of a mobile telephone 1 in accordance with the first preferred embodiment of the present invention, and FIG. 2 is a perspective view that shows the appearance of the rear face side thereof.

In the same manner as a generally-used mobile telephone, the mobile telephone 1 is provided with a speaker 11 for outputting voice from the other side of speech communication, a microphone 12 for inputting the voice of the user, operation buttons 13 for accepting various input operations and a display section 14 for displaying various information including an image on a liquid crystal display, on the front face side of a main body 10 surrounded by a casing 110. Moreover, an antenna 15 for transmitting and receiving information to and from antennas of a telephone station by radio is placed on the upper portion of the main body 10.

In the mobile telephone 1, an image pickup unit 20 for picking up an image of a subject is further formed on the upper portion of the main body 10; thus, the image picked up by the image pickup unit 20 is stored as electrical image data, and the image data is also transmitted from the antenna 15 through telephone communication.

As illustrated in FIG. 2, a joystick 16 for allowing the pivotal operation of the image pickup unit 20, which will be described later, is placed on the rear face side of the main body 10, and one portion of the virtually spherical-shaped image pickup unit 20 is exposed to the rear face. Moreover, on the side face of the main body 10, a jog dial 17 for accepting inputs from the operator is placed. Here, the joystick 16 is a device in which a rod-shape operation member is longitudinally or laterally tilted so as to make an input, and the jog dial 17 is a device in which a disc-shaped main body is rotated or pushed inside the main body 10 so as to make an input.

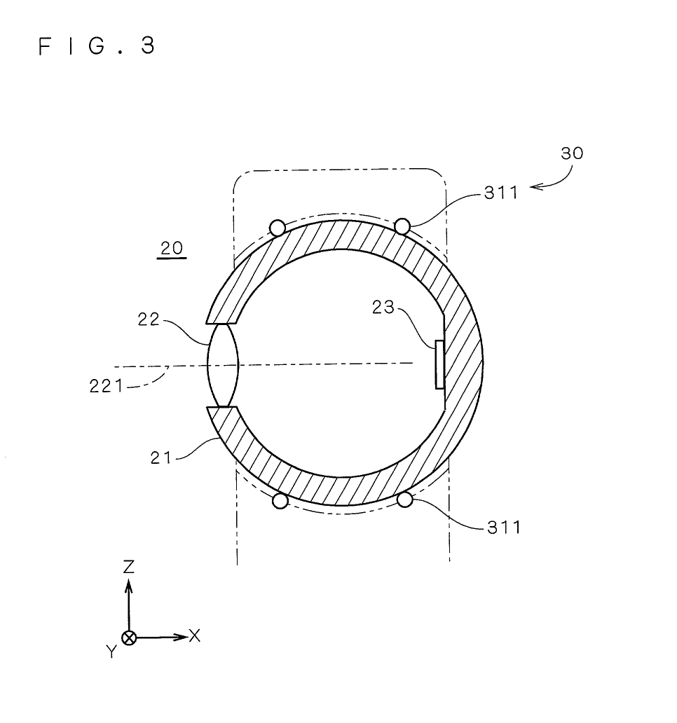

FIG. 3 is a cross-sectional view that shows one portion of the inner structure of the image pickup unit 20. The image pickup unit 20 has an arrangement in which, in a virtually spherical image pickup main body 21, a lens 22 forming an image-pickup optical system and a CCD (image pickup element) 23, which has an image of the subject formed thereon by the lens 22 and generates electrical image data of the subject, are supported. The image pickup main body 21 is supported by a pivot mechanism 30 constituted by a plurality of balls 311 and inner wall faces of the main body section 10 so as to freely pivot in a desired direction. Here, in FIG. 3, for convenience of explanation, X, Y and Z directions are indicated by arrows based upon the main body 10; and X-direction is a direction extended from the front face to the rear face of the main body 10, Y-direction is a lateral direction extended from right to left on the front face of the main body 10, and Z-direction is a longitudinal direction extended upward thereon.

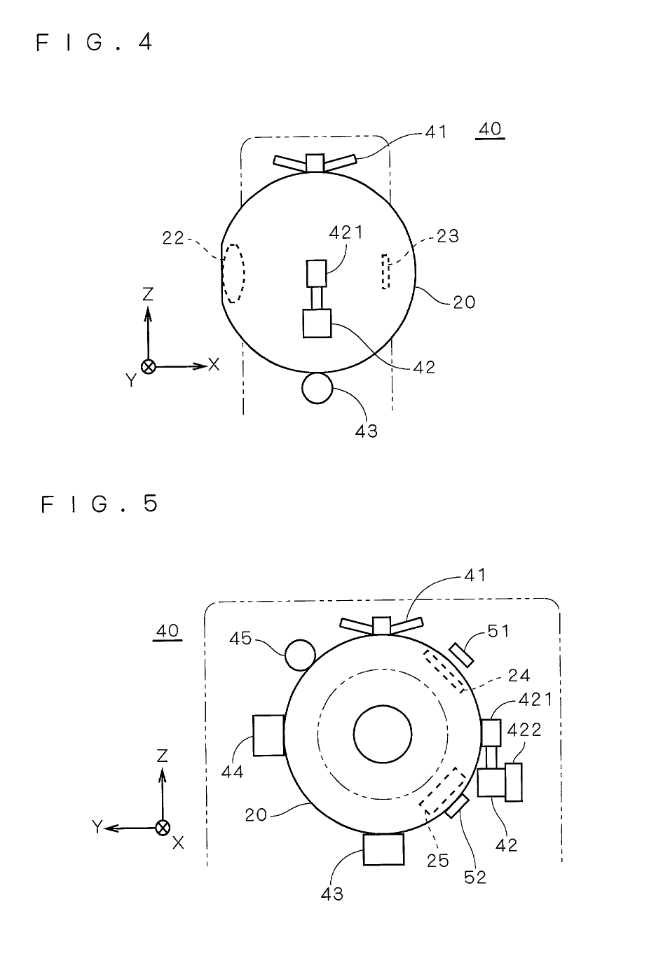

FIG. 4 and FIG. 5 are a side view and a front view that show a driving section 40 for allowing the image pickup unit 20 to pivot, together with other structures. The driving section 40 has a first driving section 41 and a second driving section 42, and is also provided with encoders 43 to 45 for detecting the amount of pivot. The first driving section 41 allows the image pickup unit 20 to pivot around X-axis as well as Y-axis by using a piezoelectric actuator, while the second driving section 42 allows the image pickup unit 20 to pivot around Z-axis by using a motor. A rotation member 421 attached to the motor axis of the second driving section 42 is allowed to freely contact and separate from the image pickup unit 20 by an actuator 422, and the rotation member 421 is allowed to separate from the image pickup unit 20 while the first driving section 41 is activated.

As illustrated in FIG. 5, the encoders 43 to 45 detect the amounts of pivot of the image pickup unit 20 around Y-axis, Z-axis and X-axis by detecting the amount of rotation of a cylinder shaped member contacting the image pickup unit 20.

A transmission circuit 24 is installed inside the image pickup unit 20 in a manner so as to communicate with a receiving circuit 51 in the main body 10. Image data, generated in the CCD 23, is transmitted from the transmission circuit 24 to the receiving circuit 51. Thus, radio communication (radio communication in accordance with a predetermined protocol used, for example, in the Bluetooth (trademark) technique, etc.) is carried out between virtually contacting objects (between the main body 10 and the image pickup unit 20).

Moreover, a battery 25 is placed inside the pickup section 20, and when the image pickup unit 20 is set in a predetermined orientation, the battery 25 is allowed to contact a power supply section 52 of the main body 10 so as to be charged. In other words, a charging position (orientation) of the image pickup unit 20 is preliminarily set, and in the case when the power capacity of the battery becomes not more than a predetermined value, the orientation of the image pickup unit 20 is forcefully changed to the charging position (a reset position that makes the light axis of the image pickup unit 20 in parallel with X-axis in an example shown in FIG. 5) so that charging is carried out.

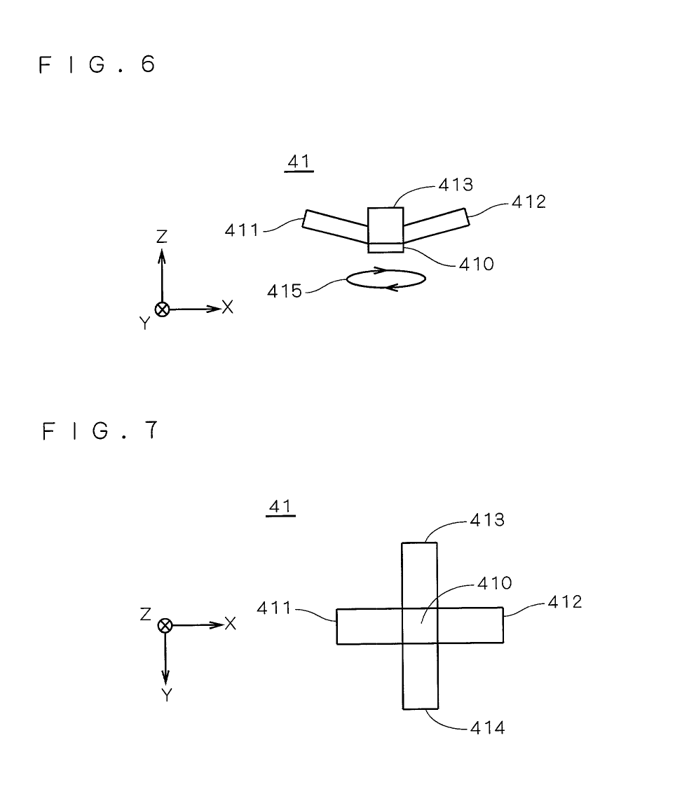

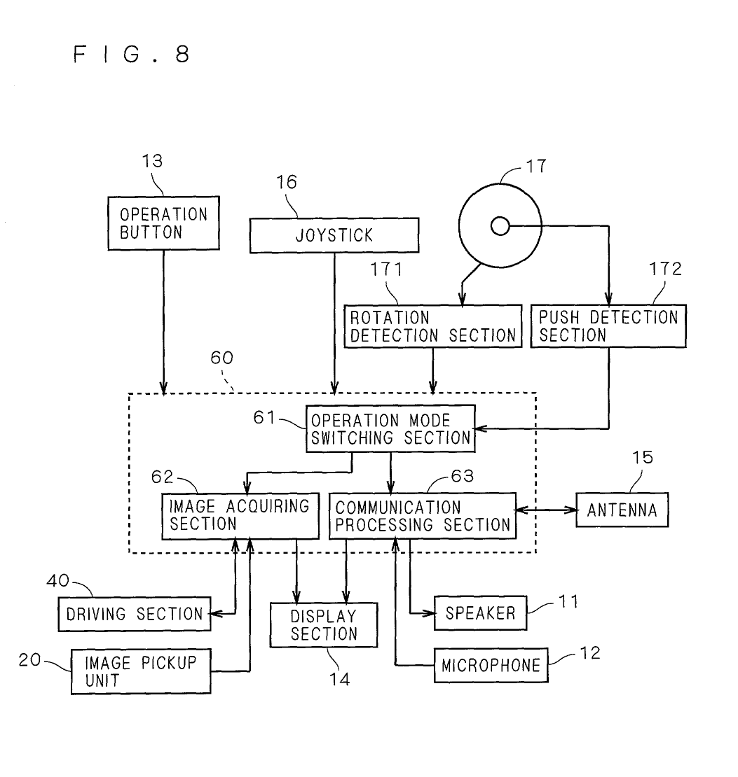

FIG. 6 is a side view that shows the structure of the first driving section 41, and FIG. 7 is a drawing that shows a state in which the first driving section 41 of FIG. 6 is viewed from below. As illustrated in FIG. 7, a frictional member 410 contacting the image pickup unit 20 is placed in the center of the first driving section 41, and the first driving section 41 has a structure in which arm members 411 to 414 are attached to the four sides of the frictional member 410. The other ends (ends on the outside) of the arm members 411 to 414 are secured to the inside of the main body 10. Each of the arm members is made of a piezoelectric member that is allowed to shrink and expand in accordance with a voltage to be applied thereto; thus, the arm members 411 and 412 function as an actuator for allowing the image pickup unit 20 to pivot around Y-axis, and the arm members 413 and 414 function as an actuator for allowing the image pickup unit 20 to pivot around X-axis.

More specifically, a sinewave voltage is applied to the arm member 411, while another sinewave voltage having a phase shifted by π/2 from this sinewave voltage is applied to the arm member 412 so that the frictional member 410 is moved along an elliptical orbit as indicated by arrow 415 in FIG. 6. Thus, the image pickup unit 20 is allowed to pivot around Y-axis. The same driving process is carried out with respect to the arm members 413 and 414 so that the image pickup unit 20 is allowed to pivot around X-axis.

Here, at the time when the image pickup unit 20 is allowed to pivot around Z-axis by the second driving section 42, the frictional member 410 is separated from the image pickup main body 21.

FIG. 8 is a drawing that schematically shows the functional structure of the mobile telephone 1. Various inputs and outputs related to the mobile telephone 1 are processed in a processing section 60, and functions of an operation mode switching section 61, an image acquiring section 62 and a communication processing section 63 placed inside the processing section 60 are achieved by a CPU that carries out operations in accordance with a program inside a ROM. One portion or all the portions of these functions may be achieved by exclusively-used electric circuits.

Operations given by the user on the operation buttons 13, the joystick 16 and the jog dial 17 are inputted to the processing section 60. Here, a rotation detection section 171, which detects the amount of rotation of the jog dial 17, and a push detection section 172, which detects the pushing operation of the jog dial 17 into the main body 10, are connected to the jog dial 17.

A detection signal from the push detection section 172 is inputted to the operation mode switching section 61, and each time it receives the detection signal of the pushing operation, the operation mode switching section 61 switches the structure to be activated between the image acquiring section 62 and the communication processing section 63. Thus, each time the pushing operation of the jog dial 17 is carried out, the operation mode of the mobile telephone 1 is switched between an image pickup mode for allowing the image acquiring section 62 to acquire an image and a communication mode for allowing the communication processing section 63 to carry out information communication processes.

In the communication mode, the mobile telephone 1 carries out operations as a normal mobile telephone. In other words, the operation of any of operation buttons 13 and the rotation operation and pushing operation of the jog dial 17 are inputted to the communication processing section 63 so that, for example, an input of a telephone number of the receiving end is carried out. Thus, a line connection is made to the terminal of the receiving end through the antenna 15 and telephone communications are made through the speaker 11 and the microphone 12. In the case when transmission or receiving of an electronic mail is carried out, the contents of the electronic mail is displayed on the display section 14, or an image is displayed thereon based upon an attached image file.

Moreover, in the communication mode, the joystick 16 is also utilized in the communication operation so that selections are made on various items through the joystick 16.

In the image pickup mode, the tilting operation of the joystick 16 in a longitudinal or lateral direction is inputted to the image acquiring section 62 so that the image acquiring section 62 sends a control signal to the driving section 40 in synchronism with the operation of the joystick 16; thus, the pivotal operation of the image pickup unit 20 is carried out. When the image pickup unit 20 is oriented in a desired direction, an image pickup operation is carried out by using the operation button 13 so that an image picked up by the image pickup unit 20 is transferred to the image acquiring section 62. Here, the image thus acquired is displayed on the display section 14, on demand. Moreover, the jog dial 17 is also used for the pivotal operation of the image pickup unit 20.

In this manner, the operation mode switching section 61 switches the operation modes between the image pickup mode in which the joystick 16 and the jog dial 17 receive operation inputs to the image pickup unit 20 and the information communication mode in which they are used for receiving operation inputs related to information communications; thus, it is possible to effectively utilize the joystick 16 and the jog dial 17 in both of the operation modes.

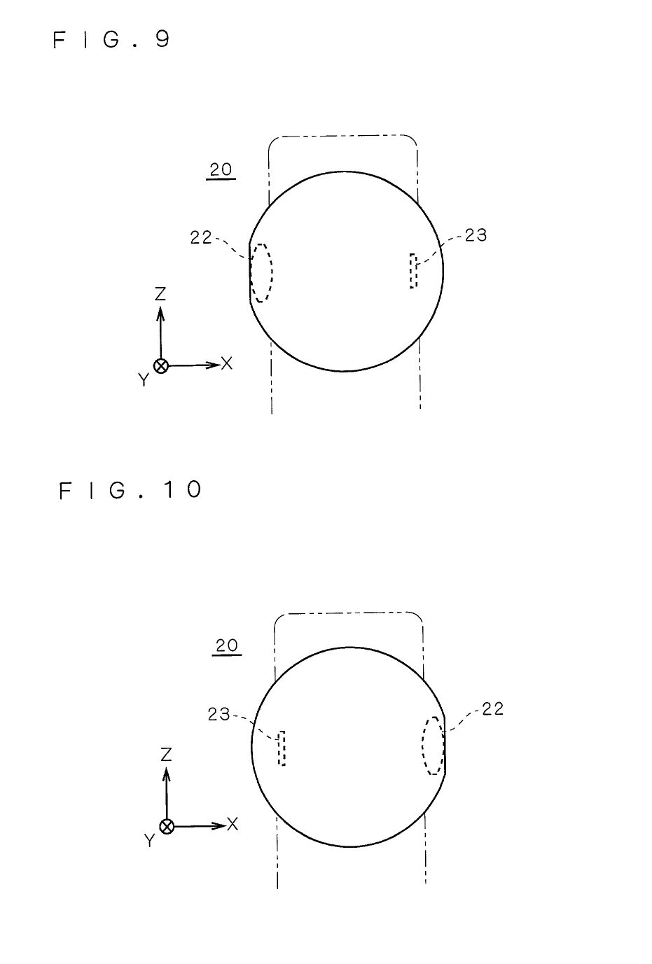

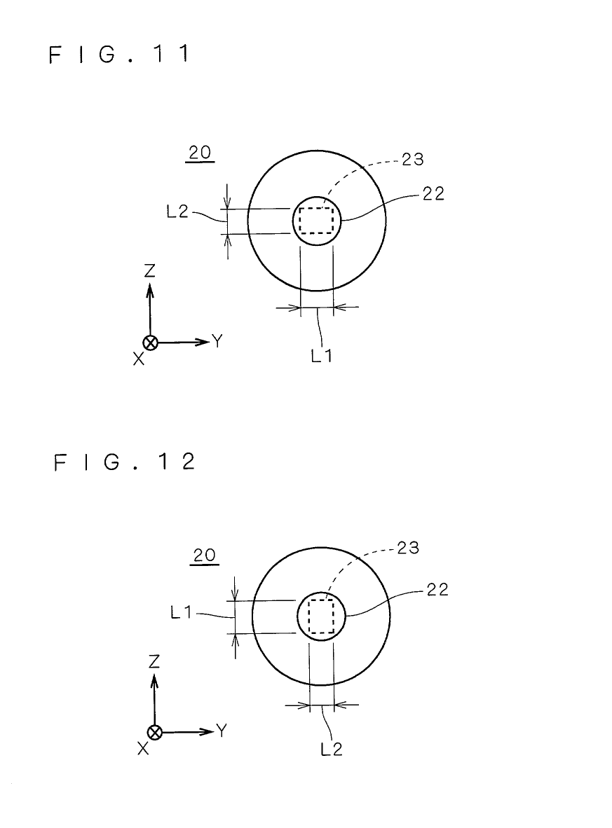

As illustrated in FIG. 2, in this mobile telephone 1, one portion of the image pickup unit 20 is also exposed to the rear face side of the main body 10. As described earlier, the driving section 40 allows the image pickup unit 20 to pivot centered on Z-axis and Y-axis by using the pivot mechanism 30 so that the image pickup unit 20 is oriented in various directions; and the image pickup unit 20 is also rotated by 180° so that the image pickup unit 20 is oriented toward the rear face side of the main body 10. In other words, in the mobile telephone 1, the image pickup unit 20 is rotated by 180° from a state shown in FIG. 9 to a state shown in FIG. 10. The input operation for rotating the image pickup unit 20 by 180° may be carried out by the operation button 13, or may be carried out by the joystick 16.

Even in the state where the image pickup unit 20 is directed on the rear face side, the image pickup unit 20 is oriented in various directions through the operation of the joystick 16 so that not only an image of the user's face on the front face side of the main body 10, but also the scenery on the rear face side of the main body 10, is easily picked up without the need of changing the orientation of the main body 10.

Moreover, in the mobile telephone 1, the image pickup unit 20 is also allowed to pivot centered on a light axis 221 shown in FIG. 3 by using the jog dial 17. In other words, the pivotal operation of the image pickup unit 20 using the joystick 16 is carried out so as to shift the image pickup unit 20 centered on Z-axis and Y-axis that are perpendicular to X-axis; however, by using the joystick 16 and the jog dial 17 cooperatively, the image pickup unit 20 is also allowed to pivot centered on the three axes.

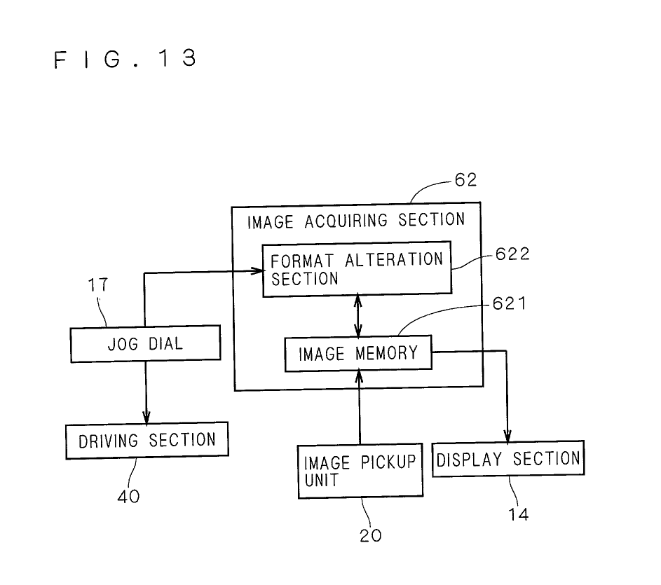

FIG. 11 is a drawing that shows a state in which the image pickup unit 20 is viewed from the lens 22 side when the light axis of the image pickup unit 20 is in parallel with X-axis, and FIG. 12 is a drawing that shows a state in which the image pickup unit 20 has been rotated by 90° around the light axis from the state shown in FIG. 11.

As illustrated in FIG. 11, the CCD 23 (more precisely, the effective image pickup area of the CCD 23) normally has an elongated shape in a lateral direction, with the length L1 in the lateral direction being longer than the length L2 in the longitudinal direction. However, the display section, used in a mobile telephone, is sometimes longer in its longitudinal length than in its lateral length. Consequently, in some cases, an image which has been picked up in the state shown in FIG. 11 is not suitable for the display on the mobile telephone of the receiving end. Therefore, in the present mobile telephone 1, the image pickup unit 20 is allowed to pivot by 90° around the light axis of the image pickup unit 20, as shown in FIG. 12, thereby making it possible to mutually exchange the longitudinal length and lateral length of the resulting image.

FIG. 13 is a block diagram that shows a functional structure that functions when the image is exchanged in its longitudinal direction and lateral direction. When the user operates the jog dial 17 so that the driving section 40 rotates the image pickup unit 20 by 90° around the light axis, this operation is also inputted to a format alteration section 622 in the image acquiring section 62.

Here, an image, picked up by the image pickup unit 20, is inputted to an image memory 621 in the image acquiring section 62. Immediately after having been inputted from the image pickup unit 20, the image is in a state rotated by 90° from the original image, since the image has been obtained with the CCD 23 being rotated by 90°. Therefore, the format alteration section 622 adjusts information related to the lateral and longitudinal directions of the image in the image memory 621 so that the image is changed in its format with its long side and short side being switched (that is, with a laterally elongated shape). The image thus changed in its format is displayed on the display section 14, on demand.

Here, the function of the format alteration section 622 is achieved by the CPU that carries out operations in accordance with a program in the ROM; and one portion or all the portions of the function may be realized by exclusively-used electric circuits.

The above explanation has been given of the mobile telephone 1 in accordance with the first preferred embodiment, and in this mobile telephone 1, the image pickup unit 20 can be rotated centered on two axes (Z-axis and Y-axis) by the pivot mechanism 30 and the driving section 40 through the joystick 16; therefore, it is possible to easily obtain a desired image without the need of changing the orientation of the main body 10. Consequently, for example, the user is allowed to pick up images of subjects located in various directions, while viewing the display section 14.

Moreover, in the mobile telephone 1, since the image pickup unit 20 can be directed not only on the front face side, but also on the rear face side of the main body 10, it is possible to pick up not only an image of the user's face on the front face side of the mobile telephone 1, but also the scenery on the rear face side of the mobile telephone 1.

Moreover, in the mobile telephone 1, since the image pickup unit 20 can be rotated centered on the light axis so as to exchange the lateral direction and the longitudinal direction of the resulting image, it is possible to obtain various kinds of images.

Additionally, in the mobile telephone 1, since the image pickup unit 20 is virtually housed inside the main body 10, it is possible to provide an integrally unified form in the appearance of the mobile telephone 1.

<2. Second Preferred Embodiment>

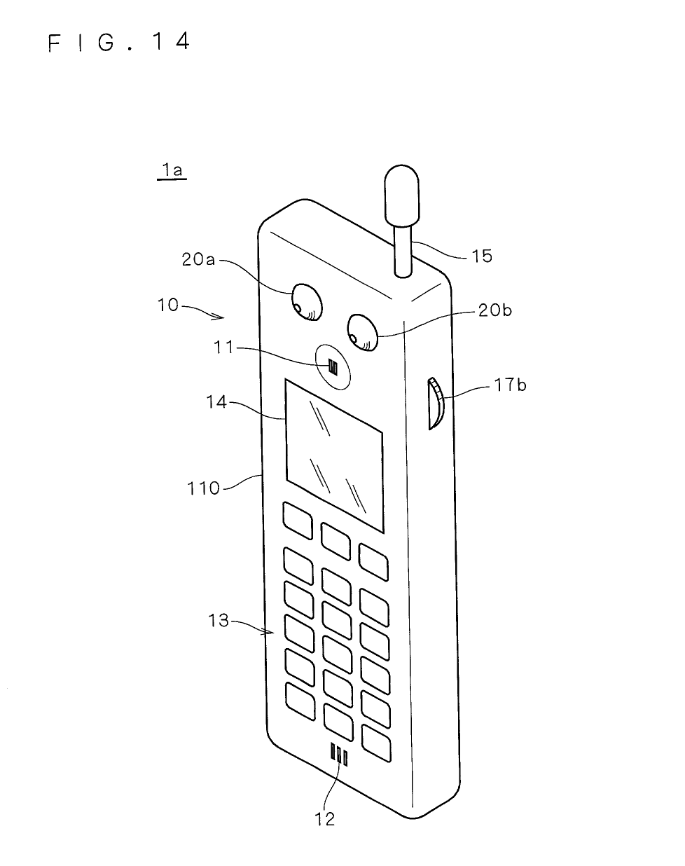

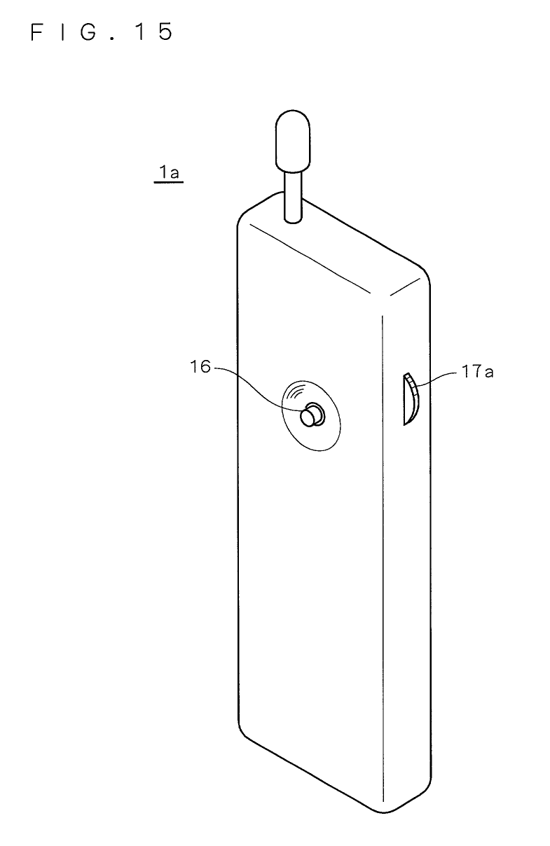

FIGS. 14 and 15 are perspective views showing the appearance of a mobile telephone la on the front face side and the rear face side, in accordance with the second preferred embodiment of the present invention.

This mobile telephone 1 a is distinct from that of the first preferred embodiment in that it has a two pairs of image pickup units (image pickup units 20a, 20b), a pivot mechanism and a driving section as well as two jog dials 17a, 17b. In the present preferred embodiment, the image pickup unit is not exposed to the rear face side. Here, those members that have the same structures as those of the first preferred embodiment are indicated by the same reference numerals. The structure of each of the image pickup units 20a, 20b and the structures of the pivot mechanism and the driving section for allowing these to pivot are the same as the image pickup unit 20, the pivot mechanism 30 and the driving section 40 of the first preferred embodiment.

In the mobile telephone la, when the joystick 16 is operated, the directions of the orientations of the two image pickup units 20a, 20b are changed in the same direction. Thus, two images, which provide a stereoscopic view of a subject, are obtained. Then, these images are transferred through the antenna 15 so that, on the receiving end, a stereoscopic view of the subject of the image pickup units 20a, 20b is realized by using an exclusively-used three-dimensional image display device (for example, a device for displaying respective two images onto the two eyes of a person). Of course, since the image pickup units 20a, 20b are allowed to pivot centered on the two axes by the pivot mechanism 30, the user of the mobile telephone 1a can pick up a desired image of a subject without the need of changing the direction of the main body 10.

The two jog dials 17a, 17b are used when the orientations of the two image pickup units 20a, 20b are changed independently. The jog dial 17a relates to the pivotal operation of the image pickup unit 20a, and the jog dial 17b relates to the pivotal operation of the image pickup unit 20b. In the same manner as the first preferred embodiment, each of the jog dials 17a, 17b is provided with the rotation detection section and the push detection section.

When it is rotatively operated, the jog dial 17a carries out the pivotal operation (see FIG. 4 and FIG. 5) of the image pickup unit 20a around Z-axis or Y-axis. Here, it is determined by the pushing operation whether the rotation operation of the jog dial 17a results in the pivotal operation around Z-axis or the pivotal operation around Y-axis. In other words, each time the pushing operation is carried out, the switching is made between the pivotal operation around Z-axis and the pivotal operation around Y-axis at the time when the rotation of the jog dial 17a. The same is true for the jog dial 17b. Therefore, the orientations of the two image pickup units 20a, 20b are independently changed by using the jog dials 17a and 17b, with the result that two different images can be obtained virtually at the same time.

Moreover, the further pushing operation may be set to switch the rotation operation of the jog dial 17a, 17b to the operation for communications.

As described above, in the mobile telephone la, the orientations of the two image pickup units 20a, 20b can be changed in the same direction by using the joystick 16, and can also be changed independently from each other by using the two jog dials 17a, 17b.

Here, the two image pickup units 20a, 20b may be used for purposes other than the purpose of obtaining a stereoscopic image. For example, the focal distance of the image pickup unit 20a may be set shorter, with the focal distance of the image pickup unit 20b being set longer; thus, this may be used as a so-called double focus camera. Thus, an image focused on a main subject in the vicinity of the mobile telephone 1 a and an image focused on the background are obtained, and by properly composing (for example, trimming) these images, an image that clearly represents both the main subject and the background can be obtained. Moreover, in the case when adjacent continuous images are obtained by the two image pickup units, these may be joined to each other to form a wide angle panorama image.

Furthermore, the two image pickup units 20a, 20b may be moved in a converging manner depending on the distances to the main subject. Thus, it becomes possible to obtain images that form a more natural stereoscopic image.

Thus, the mobile telephone 1a in accordance with the second preferred embodiment, which is provided with two pairs of the image pickup units and pivotal mechanisms, makes it possible to obtain various images.

<3. Third Preferred Embodiment>

Next, an explanation will be given of a third preferred embodiment that automatically carries out the pivotal movement of the image pickup unit 20 of the mobile telephone 1 in accordance with the first preferred embodiment. Here, in the following explanation, the same reference numbers as the first preferred embodiment are used on demand.

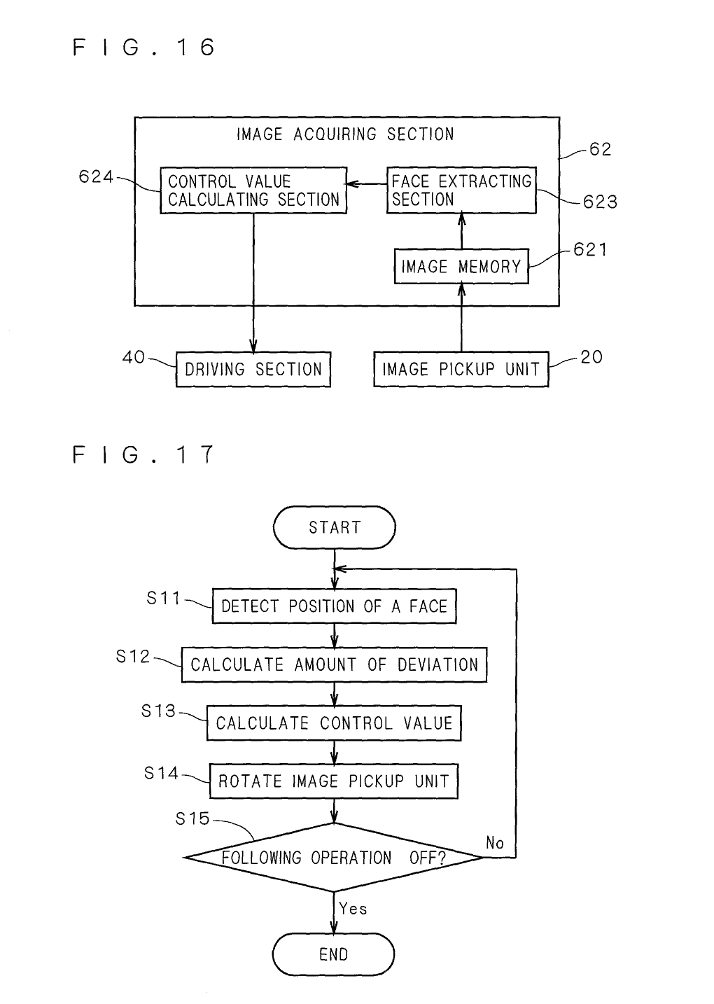

FIG. 16 is a block diagram that shows a functional structure of an image acquiring section 62 used in the case when, upon picking up an image of a person's face by using the image pickup unit 20, the image pickup unit 20 is allowed to automatically pivot so as to place the position of a person's face in an image virtually in the center of the image. A face extracting section 623 and a control value calculating section 624 of the image acquiring section 62 have functions that are realized by the CPU that carries out operations in accordance with programs in the ROM. One portion or all the portions of these functions may be realized by exclusively-used electric circuits.

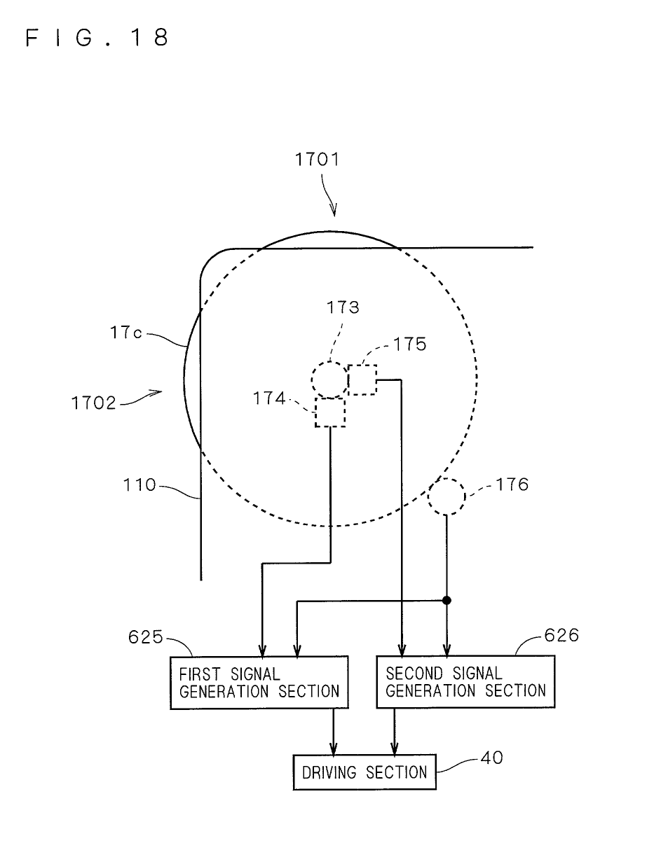

FIG. 17 is a flow chart that shows a sequence of processes of the mobile telephone 1 in the case when the image pickup unit 20 is allowed to pivot in accordance with the position of a person's face. First, the face extracting section 623 extracts the area of a person's face in an image stored in the image memory 621. Colors, which should be judged as human faces, are preliminarily stored in the face extracting section 623 as colors within predetermined ranges in color space. Then, a judgment is made as to whether or not the value of each pixel corresponds to the color of a human face, and the greatest cluster that belongs to the color of the human face is extracted as an area of a person's face in the image. Thereafter, the position of the center of gravity of the extracted area is found as the position of the person's face (step S11).

Next, the amount of deviation between the position of the person's face and the center of the image is calculated (step S12). Further, the amount of pivot of the image pickup unit 20 which is required for making the amount of deviation zero is found so that a control value to be given to the driving section 40 is calculated (step S13). Then, based upon the control value thus found, a control signal is transferred to the driving section 40, thereby allowing the image pickup unit 20 to pivot (step S14). Consequently, the image pickup unit 20 is directed virtually in front of the person's face, thereby making it possible to obtain an image with the person's face positioned virtually in the center thereof.

The above-mentioned operations are repeated until the operation mode for allowing the image pickup unit 20 to follow the person's face has been released (step S15) so that, even when the relative position of the person's face is changed with respect to the main body 10, the image pickup unit 20 pivots in a manner so as to follow the person's face. Consequently, without the necessity of taking account of the orientation of the main body 10, it is possible for the user to easily photograph his own face on the front side of the main body 10 or the face of another person staying behind the main body 10. For example, it becomes possible for the user to photograph the face of another person staying behind the main body 10, while using the telephone. Beside these, it may be designed to pivot following sound or lightness.

<4. Fourth Preferred Embodiment>

In the first and second preferred embodiments, the operation for allowing the image pickup unit 20 to pivot (around Z-axis and Y-axis) is carried out by using the joystick 16; however, a fourth preferred embodiment exemplifies a case in which the operational inputs to the image pickup unit 20 is carried out by using one jog dial. Here, the mobile telephone in accordance with the fourth preferred embodiment has the same arrangement as the first preferred embodiment except that the joystick 16 in the first preferred embodiment is replaced by one jog dial.

FIG. 18 is a drawing that shows a jog dial 17c and structures related to the jog dial 17c used for operating the image pickup unit 20 of a mobile telephone in accordance with the fourth preferred embodiment. The disc-shaped jog dial 17c is supported on a left upper corner of a casing 110 of the main body 10 so as to freely rotate centered on an axis 173, and an area 1701 on the upper side of the jog dial 17c and an area 1702 on the left side thereof are designed to stick out from the main body 10.

A pressure sensor 174 for detecting the fact that the finger of the user touches the area 1701 and a pressure sensor 175 for detecting the fact that the finger of the user touches the area 1702 are connected to the shaft 173 of the jog dial 17c. Moreover, a rotation detector 176 for detecting the amount of rotation is placed on the periphery of the jog dial 17c.

A first signal generation section 625 and a second signal generation section 626, which form one portion of the image acquiring section 62, have functions that are achieved by the CPU that carries out operations in accordance with programs in the ROM, and one portion or all the portions thereof may be realized by exclusively-used electric circuits.

Signals from the pressure sensor 174 and the rotation detector 176 are inputted to the first signal generation section 625, and this is activated only in the case when the detection signal from the pressure sensor 174 is inputted so that the amount of rotation of the jog dial 17c, sent from the rotation detector 176, is converted to the amount of pivot of the image pickup unit 20 around Z-axis, and the resulting signal is outputted to the driving section 40. Signals from the pressure sensor 175 and the rotation detector 176 are inputted to the second signal generation section 626, and this is activated only in the case when the detection signal from the pressure sensor 175 is inputted so that the amount of rotation of the jog dial 17c from the rotation detector 176 is converted to the amount of pivot of the image pickup unit 20 around Y-axis, and the resulting signal is outputted to the driving section 40.

Thus, when the user rotates the jog dial 17c while touching the area 1701, the image pickup unit 20 is allowed to pivot around Z-axis, and when the user rotates the jog dial 17c while touching the area 1702, the image pickup unit 20 is allowed to pivot around Y-axis. Consequently, inputs of two parameters are realized by using one jog dial 17c so that the pivotal operations of the image pickup unit 20 centered on the two axes are carried out.

Here, as long as the fact that the finger of the user touches the area 1701 or 1702 is detected, that is, as long as forces in different two directions that are exerted on the jog dial 17c are virtually detected, any sensors may be used in place of the pressure sensors 174 and 175. For example, by utilizing the force that is exerted on the jog dial 17c, a detection may be made as to which area the finger of the user is touching based upon ON/OFF of two electrostatic switches connected to the shaft 173.

<5. Modified Examples>

The above descriptions have discussed the preferred embodiments of the present invention; however, the present invention is not intended to be limited by these preferred embodiments, and various modifications may be made therein.

In the first and second preferred embodiments, the pivotal operations around Z-axis and Y-axis of the image pickup unit 20 are carried out by using the joystick 16; however, with respect to the input means for the pivotal operations, another means may be used.

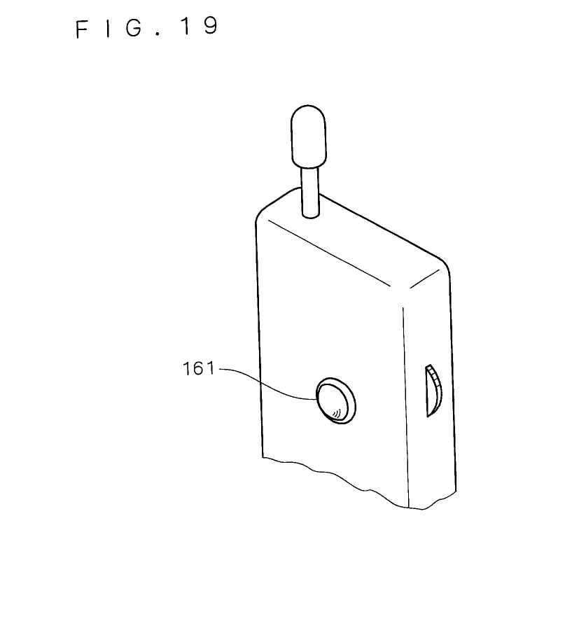

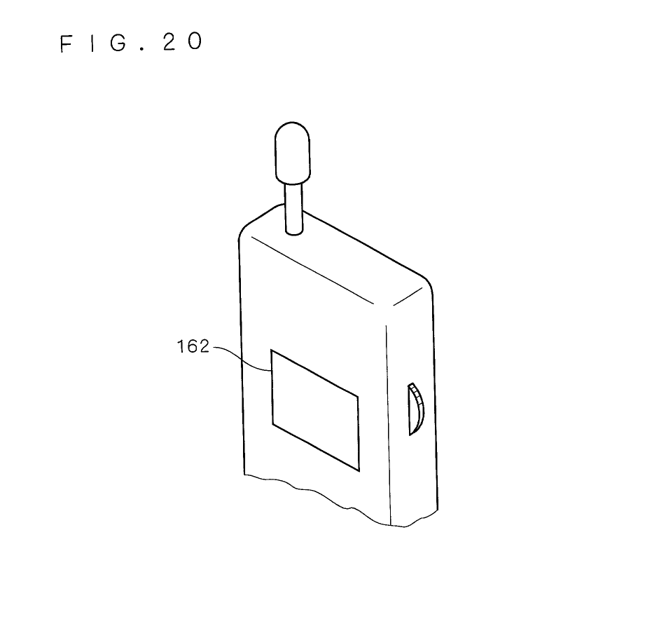

For example, as illustrated in FIG. 19, instead of the joystick 16, a track ball 161 (a device for inputting two parameters by detecting the rotation of a ball) may be installed. Alternatively, as illustrated in FIG. 20, a track pad 162 (a device for inputting two parameters by shifting a finger while touching a two-dimensional array of sensors of an electrostatic type or a pressure-sensitive type) may be installed. A track point, which detects the direction and magnitude of a force that is exerted on an operation member having a sticking shape by utilizing a piezoelectric element, may be used. These input means are utilized in computers as so-called pointing devices.

Besides these input means, the jog dial 17c may of course be utilized as described in the fourth preferred embodiment, and any means may be used as long as at least two parameters are inputted as parameters for allowing the image pickup unit 20 to pivot.

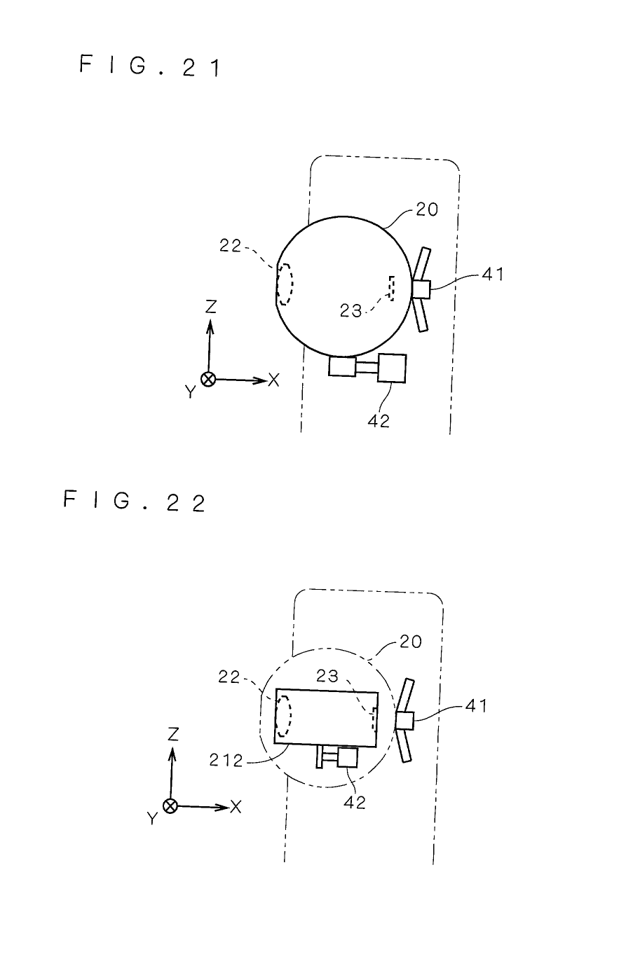

Moreover, in the first preferred embodiment, the image pickup unit 20 is allowed to pivot centered on the three axes by using the first driving section 41 and the second driving section 42; however, with respect to the structure of the driving section 40, any structure may be used. FIG. 21 is a drawing that shows an example in which the positions of the first driving section 41 and the second driving section 42 are modified with respect to the image pickup unit 20. In FIG. 21, the first driving section 41 carries out the pivotal operations of the image pickup unit 20 around Z-axis and Y-axis, and the second driving section 42 carries out the pivotal operation around X-axis. In the case when the pivotal operation around X-axis is not necessary (that is, in the case when no format alteration for replacing the longitudinal direction and the lateral direction of an image is made), of course, the second driving section 42 is not necessary.

FIG. 22 is a drawing that shows an example in which, in FIG. 21, the second driving section 42 is placed within the image pickup unit 20. In FIG. 22, the lens 22 and CCD 23 of the image pickup unit 20 are held in a cylinder-shaped holder 212, and the holder 212 is allowed to pivot around X-axis by the second driving section 42. Thus, the number of members to be placed on the periphery of the image pickup unit 20 is reduced.

With respect to another example of the driving section 40, a structure in which three motors are placed on the periphery of the image pickup unit 20 may be used.

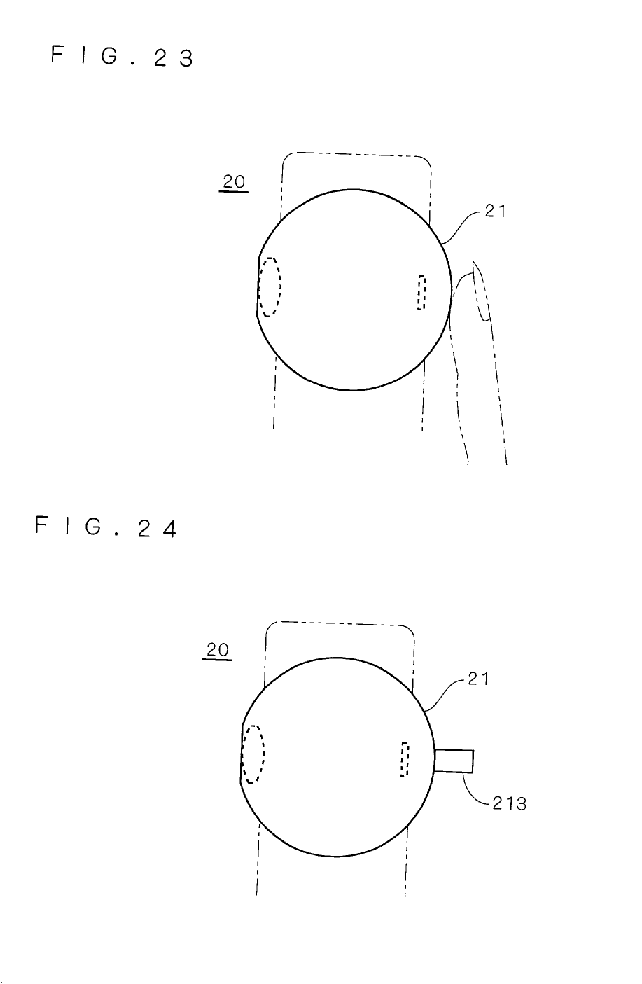

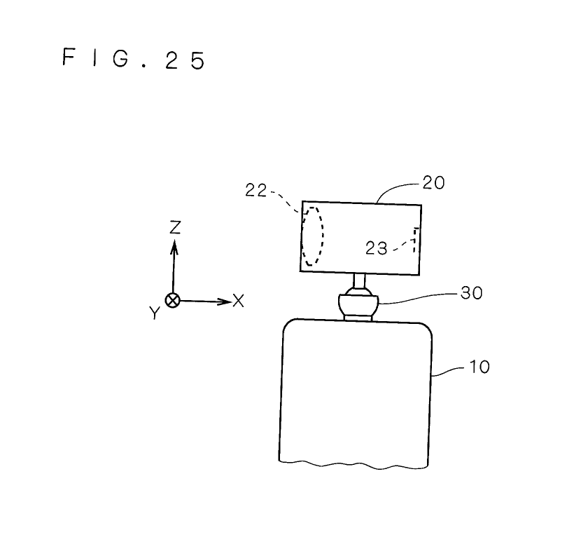

Moreover, in the above-mentioned preferred embodiment, the image pickup unit 20 is allowed to pivot by the driving section 40; however, the pivotal operation of the image pickup unit 20 may be carried out by the finger of the user. For example, as illustrated in FIG. 23, in the first preferred embodiment, the first driving section 41 and the second driving section 42 are omitted, and the user may rotate the image pickup unit 20 by touching the image pickup main body 21 with the finger from the rear face. Alternatively, as illustrated in FIG. 24, a rod-shaped member 213 may be attached to the rear face of the image pickup main body 21 so that the pivotal operation of the image pickup unit 20 may be carried out in the same manner as the operation of a joystick.

Moreover, as illustrated in FIG. 25, a coupling may be used as the pivot mechanism 30 so that the image pickup unit 20 may be supported so as to pivot around two axes (Z-axis and Y-axis) outside the main body 10. In other words, with respect to the pivot mechanism 30, any mechanism may be used as long as the orientation of the image pickup unit 20 is fixed to the main body 10 in a state where the user does not touch the image pickup unit 20.

Furthermore, with respect to the pivot mechanism that allows the image pickup unit 20 to pivot around X-, Y- and Z-axes, it is not limited to a form regarded as a signal mechanism; and respectively independent mechanisms may be used. In other words, the pivot mechanism 30 may be provided as a collection of a plurality of pivot mechanisms.

In the aforementioned first preferred embodiment, an explanation has been given in such a manner that the image pickup unit 20 pivots centered on the light axis 221; however, any pivot mechanism may be used as long as this is rotated by 90° centered on an axis in parallel with the light axis 221.

Moreover, in the above-mentioned preferred embodiments, explanations have been given in such a manner that the image pickup unit 20 is allowed to pivot around at least two axes (Z-axis and Y-axis) determined based upon the main body 10; however, in the case when the driving section 40 is secured onto the image pickup unit 20, these axes are determined based upon the image pickup unit 20. In this manner, the axis forming the center on which the image pickup unit 20 is allowed to pivot is not limited to an axis secured to the main body 10. Moreover, these axes are not necessarily orthogonal to each other.

The fourth preferred embodiment has an arrangement in which the fact that the user touches the jog dial 17c is detected; however, the image pickup unit 20 and image acquiring section 62 may be activated only when the user touches the jog dial 17c.

Moreover, the above-mentioned preferred embodiments have exemplified a case in which a mobile telephone that carries out information communications by radio is used; however, information communications may be made through lines, and an image pickup unit which is allowed to pivot centered on at least two axes may be attached to a personal computer, or a PDA, etc., that is a terminal capable of carrying out information communications in the same manner as a mobile telephone.

While the invention has been shown and described in detail, the foregoing description is in all aspects illustrative and not restrictive. It is therefore understood that numerous other modifications and variations can be devised without departing from the scope of the invention.

What is claimed is:

1. A portable terminal for transmitting and receiving information comprising:
a main body;
an image pickup unit having an optical system and an image pickup element, for picking up an image of a subject; and
a pivot mechanism for supporting said image pickup unit, said image pickup unit being allowed to freely pivot centered on at least two axes with respect to said main body.

2. The portable terminal according to claim 1, wherein said image pickup unit is virtually housed into said main body.

3. The portable terminal according to claim 1, further comprising:
a driving section for allowing said image pickup unit to pivot centered on at least two axes; and
an input section for receiving inputs of at least two parameters as operation inputs of a pivotal operation of said image pickup unit.

4. The portable terminal according to claim 1, wherein said image pickup unit is directed to a front face side and a rear face side of said main body.

5. The portable terminal according to claim 1, wherein said image pickup unit is allowed to pivot centered on an axis parallel to a light axis of said optical system by said pivot mechanism.

6. The portable terminal according to claim 1, further comprising:
a switching section for switching operation modes between an image pickup mode for allowing said input section to receive said operation inputs with respect to said image pickup unit and a communication mode for allowing said input section to receive an operation input related to information communication.

7. The portable terminal according to claim 1, wherein two pairs of said image pickup units and said pivot mechanisms are installed.

8. The portable terminal according to claim 3, further comprising:
a section for detecting a position of a specific subject in said image; and
a section for controlling said driving section so as to place said specific subject virtually in a center of said image.

9. The portable terminal according to claim 3, wherein:
said input section comprises:
a disc-shaped rotation member that is rotatively driven;
a section for detecting an amount of rotation of said rotation member;
a section for detecting a force in a first direction given to said rotation member; and
a section for detecting a force in a second direction given to said rotation member,
wherein two parameters included in said at least two parameters are inputted as said amount of rotation detected together with a detection of said force in said first direction and as said amount of rotation detected together with a detection of said force in said second direction.
